(19) United States
(12) Patent Application Publication
(10) Pub. No.: US 2015/0053677 A1
(43) Pub. Date: Feb. 26, 2015

(54) CONTAINER AND NOZZLE

(71) Applicant: Mark Gordon, (US)

(72) Inventors: James A. Yocum, West Chester, PA (US); Richard W. Jones, Barnegat, NJ (US)

(21) Appl. No.: 14/464,670

(22) Filed: Aug. 20, 2014

Related U.S. Application Data
(60) Provisional application No. 61/869,229, filed on Aug. 23, 2013.

(51) Int. Cl. B67C 11/02; B67D 7/04

(52) U.S. Cl. CPC B67C 11/02; B67D 7/04
USPC 220/86.1; 141/337

(57) ABSTRACT

In the container and nozzle disclosed, the nozzle is formed from a die cut sheet and mounted to the container in flat condition for storage and transport. The nozzle has a tab at an upper end and a pour channel at a lower end. The tab has an aperture with radially oriented slits to be pressed over threads on the container neck and thereby held in position. The pour channel has four panels and a glue panel joined by score lines to be expandable from the flat condition to an open condition for allowing a material to flow through. A number of slits are cut through the sheet along a juncture between the tab and the pour channel, the slits allowing the pour channel to be fully expanded with minimum distortion.

### RELATED APPLICATION

This application is a conversion of provisional patent application No. 61/869,229 filed Aug. 23, 2013.

### FIELD OF THE INVENTION

The present invention relates to the field of containers for storing pourable materials, and for nozzles used in the transfer of materials, the pourable materials being either liquid or granular.

### BACKGROUND OF THE INVENTION

Containers filled with an emergency fuel for automobile or other internal combustion engines are available for when the automotive or other gasoline tank is empty and no other source of additional fuel is nearby. In order for the emergency fuel to remain usable during a long period of storage, the fuel is custom formulated. Such a container and special fuel are described in U.S. Pat. Nos. 6,110,237 to Spencer et al. and No. 6,113,660 to Hubbard et al.

The containers used for storage of an emergency automobile fuel and the nozzles for dispensing same prior to the present invention are typically made of either metal or plastic. While metals and most plastics can be recycled after use, they require considerable natural resources to be manufactured. The metal or plastic nozzles used require excess storage space, whether external of the container or stored within the container. In addition, the manufacturing steps for a metal or plastic nozzle and subsequent assembly to a container are comparatively intricate.

U.S. Pat. No. 7,237,583 to Salani et al. is for a Multipurpose Collapsible Funnel. The Salani et al. funnel is formed of die cut paperboard that is scored for folding and gluing into a tapered shape with a fluid inlet and a fluid outlet. The Salani et al. funnel is folded into a form having at least four thicknesses for transport and storage. When the fuel in the container is to be poured, the funnel is unfolded and held in position at the gas tank filler or other receptor for the fuel. This involves one hand to hold the funnel and one hand to hold the container.

### SUMMARY OF THE INVENTION

The present invention container and nozzle overcomes the drawbacks of the previously known container/nozzle combinations in an environmentally friendly manner. The nozzle is formed from flat sheet material that is glued together at the edges and folded flat. An upper tab is integrally connected to a pour channel of the nozzle, the tab having an opening adapted for being placed over the neck of the container. For shipping and storage, the pour channel of the nozzle remains flat and is pressed against the side of the container. A juncture between the tab and the pour channel is formed with one or more slits to allow the pour channel of the nozzle to be fully expanded from flat to open condition in a manner to facilitate the pouring of the liquid or granular material from the container.

### BRIEF DESCRIPTION OF THE DRAWINGS

The present invention is best understood in conjunction with the accompanying drawing figures in which like elements are identified by similar reference numerals and wherein:

FIG. 1 is a perspective view of the container and nozzle of the present invention in storage condition.

FIG. 2 is a plan view of the nozzle of the present invention as cut from a sheet.

FIG. 3 is a side elevation view of the container and nozzle of the present invention as the stored material begins to be dispensed from the container through the nozzle.

FIG. 4 is the view of FIG. 3 with the container tilted further to dispense the stored material.

FIG. 5A is a top plan view of the nozzle of the invention in collapsed condition.

FIG. 5B is a side elevation view of the nozzle of FIG. 5A.

FIG. 6A is a top plan view of the nozzle of FIG. 5A in expanded condition.

FIG. 6B is a side elevation view of the nozzle of FIG. 6A.

### DETAILED DESCRIPTION OF THE PREFERRED EMBODIMENT

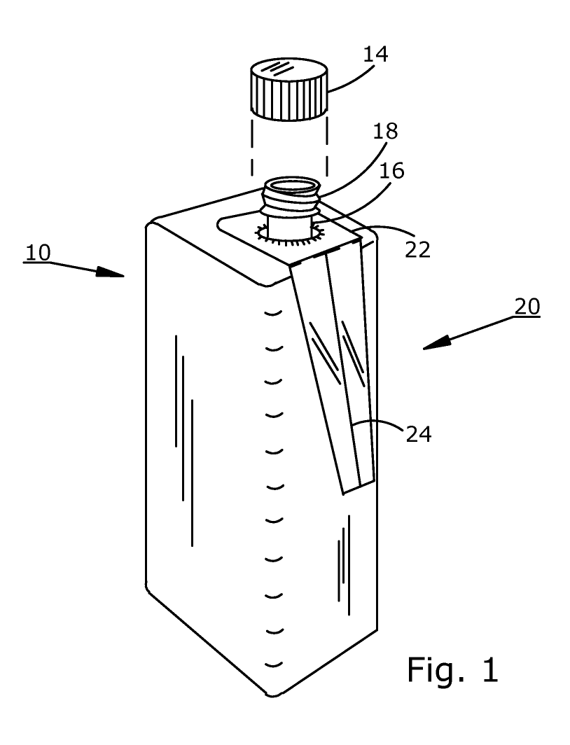

Referring to FIG. 1, a container 10 is illustrated in perspective view with a nozzle 20 mounted thereto according to the preferred embodiment of the invention. Container 10 has a neck 16 at the upper end thereof with external threads 18 formed thereon. A cap 14 is shown after being removed from neck 16, cap 14 having mating internal threads (not shown) to engage threads 18 when assembled. In an alternate embodiment, neck 16 may be formed with a snap engagement cap having an enlarged upper end. Nozzle 20 has an integrally connected tab 22 that mounts over neck 16 of container 10. As illustrated, the body portion of nozzle 20 is substantially flat and positioned adjacent and parallel to a sidewall of container 10 for storage and transport. A seam 24 is shown to bisect the exposed surface of nozzle 20, seam 24 will be described below to enable expansion of nozzle 20 to an open condition for controllably dispensing a pourable material from container 10.

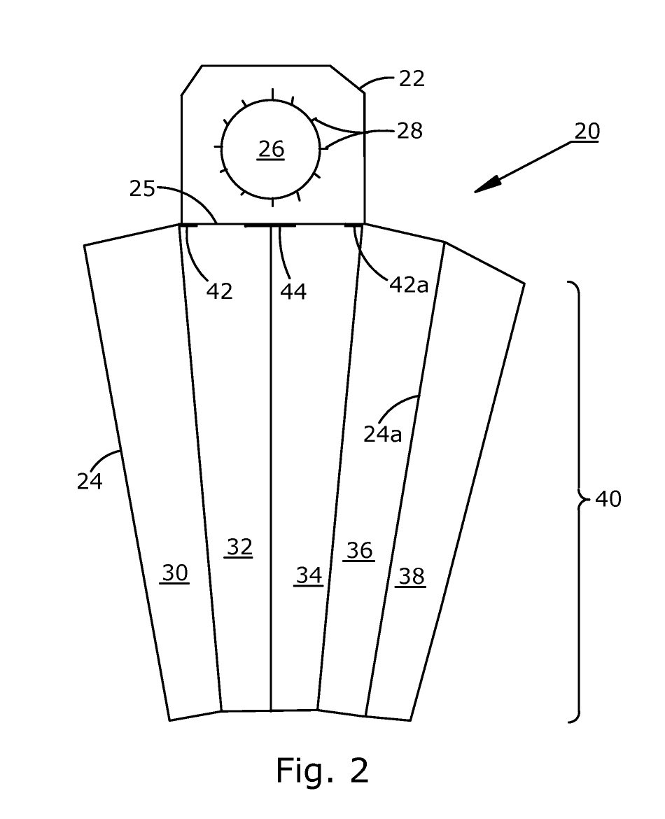

Referring now to FIG. 2, nozzle 20 is illustrated in flat form after being die cut from a planar sheet. The sheet from which nozzle 20 is formed may be paperboard or other conformable sheet material. In the preferred embodiment, the sheet is a paperboard of primarily recycled stock with a coating that is resistant to liquid absorption. Tab 22 is formed with an aperture 26 punched therethrough and a series of radially oriented slits 28 emanating outwardly from aperture 26. The diameter of aperture 26 is larger than the diameter of neck 16 (see FIG. 1) and smaller than the diameter of threads 18. Slits 28 permit tab 22 to be pressed over threads 18 and to remain entrapped around neck 16. Tab 22 is joined to panels 30, 32, 34, 36 and 38 by a juncture 25.

Referring further to FIG. 2, a series of panels 30, 32, 34, 36 and 38 make up nozzle 20 and are defined by score lines therebetween. When assembled during the manufacturing process, glue panel 38 is folded forward to engage the inner surface of front panel 30, with front panel 30 overlaying rear panel 32, and front panel 36 overlaying rear panel 34. An adhesive is applied during manufacture to hold glue panel 38 to front panel 30. When assembled and glued, seam 24 is positioned over seam 24a, and glue panel 38 is below front panel 30. As will be described below, the resultant formation is a flat nozzle that is able to be expanded to a three dimensional shape, preferably a truncated and inverted pyramid shape. In folded condition, there are two thicknesses of sheet material where panels 34 and 36 are overlapped, and three thicknesses of sheet where panels 30, 32 and 38 are overlapped. The lower edges of each panel 30, 32, 34, 36, and 38 are narrower than the respective upper edges thereof, thereby enabling the formation of a pour channel 40 that tapers inwardly from top to bottom.

Continuing with FIG. 2, juncture 25 connects panels 32 and 34 to tab 22. Juncture 25 is formed as a score line with one or more slits cut therethrough. A central slit 44 resides over the score line between panels 32 and 34. Side slit 42 is formed at the corner joining tab 22 with panel 32, and side slit 42a is formed at the corner joining tab 22 with panel 34. Slits 42, 42a and 44 enable the controlled expanding of nozzle 20 when required for guiding a material being dispensed from container 10 as seen in FIG. 1.

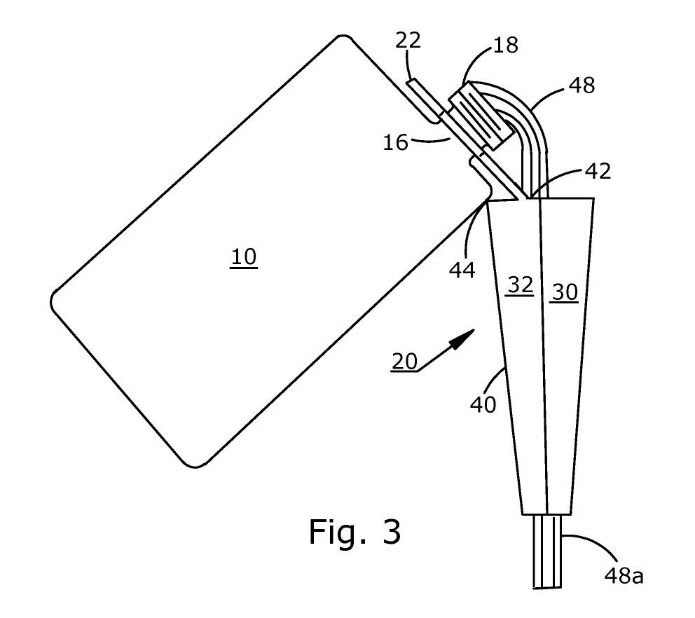

Referring now to FIG. 3, tab 22 is engaged on neck 16 and the lower portion of nozzle 20 has been expanded to form a pour channel 40. Nozzle 20 is held to neck 16 by tab 22 to ensure that pourable material 48 enters and flows through expanded pour channel 40. Front panel 30 and rear panel 32 are seen in angular orientation relative to one another. Front panel 36 and rear panel 34 reside respectively behind front panel 30 and rear panel 32 and are not seen in this view. When pour channel 40 is expanded, central slit 44 opens to allow score line 25 (see FIG. 2) between rear channel 32 and rear channel 34 (not visible) to extend under tab 22 to permit pour channel 40 to open fully. At the same time, side slit 42 and side slit 42a (not visible) open to allow the score line between rear panel 32 and front panel 30 to reside forward of tab 22, with the score line between rear panel 34 (not visible) and front panel 36 (not visible) to reside similarly forward on the opposite side of pour channel 40. As container 10 is tilted, a pourable liquid or granular material 48 flows from container 10 through pour channel 40 to an intended destination, e.g. a gasoline tank of a vehicle. In this initial pouring stage, material 48 flows generally into the central area of pour channel 40. The distance from aperture 26 (see FIG. 2) to pour channel 40 is configured to permit the pourable material to flow out from neck 16 into pour channel 40 throughout the process of emptying container 10.

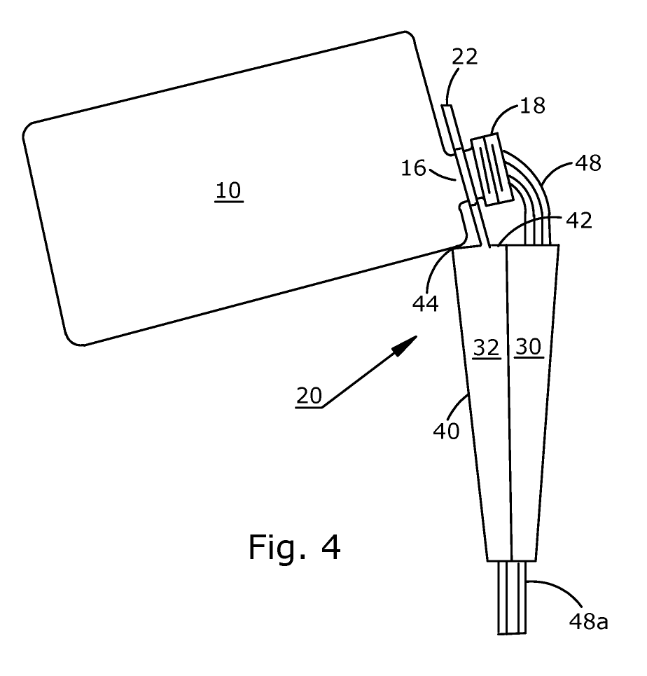

Referring now to FIG. 4, the majority of material has been poured from container 10 and container 10 is tilted to a greater angle to dispense the remainder of material 48 therefrom. In this stage, material 48 generally flows into the outer portion of pour channel 40. By providing slits 42 and 44, pour channel 40 opens fully, thus ensuring optimum control of material 48 and minimizing the chance of leakage throughout the pouring sequence.

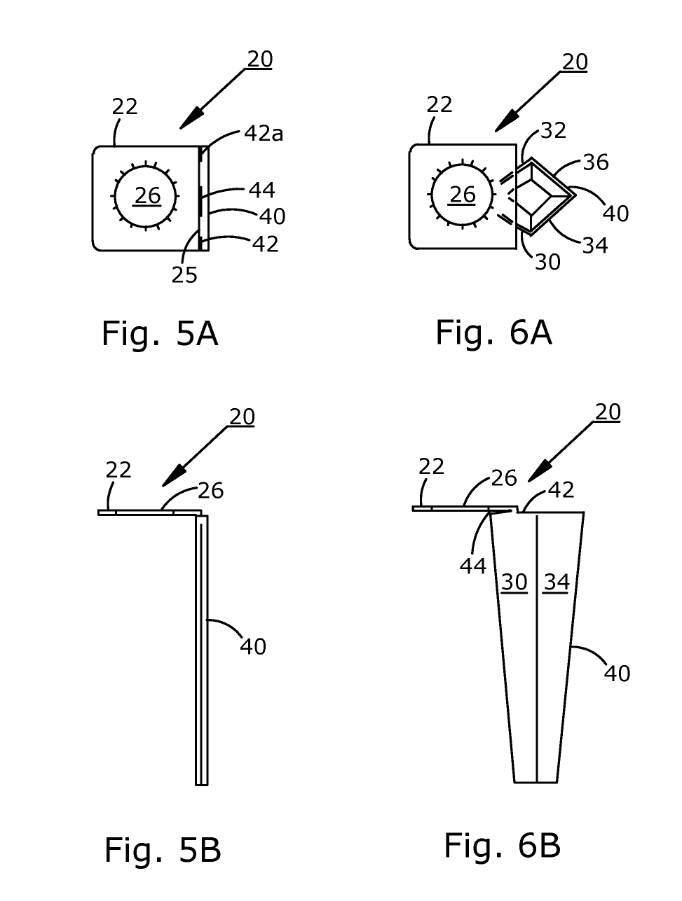

Referring now to FIGS. 5A and 5B, nozzle 20 is shown in top plan view and side elevation view, respectively, in flat folded condition to rest against the side of container 10 (see FIG. 1). Side slits 42, 42a and central slit 44 are shown along juncture 25 between tab 22 and pour channel 40. In this flat folded condition, nozzle 20 requires little space for storage or transport beyond the space required for container 10.

Referring now to FIGS. 6A and 6B, pour channel 40 has been expanded by pressing the side edges between panels 32, 36 and panels 30, 34 in toward each other. Central slit 44 allows the score line between rear panel 30 and rear panel 32 to move inward until contacting the container neck, as represented by aperture 26. Similarly, side slits 42 and 42a (see FIG. 5A) allow the score line between rear panel 30 and front panel 34 and the score line between rear panel 32 and front panel 36 to expand forward of the edge of tab 22. In this manner, pour channel 40 expands with a minimum of distortion to provide a sufficient inner volume to accommodate and control the material flowing therethrough. The material within the container can therefore be controllably poured as shown in FIGS. 3 and 4.

While the description above discloses preferred embodiments of the present invention, it is contemplated that numerous variations of the invention are possible and are considered to be within the scope of the claims that follow.

What is claimed is:

1. A container and nozzle, comprising:
a. a container for storing a pourable material, the container comprising a neck formed with an upper portion having a larger diameter than a lower portion thereof;
b. a nozzle formed of sheet material with a tab connected to a pour channel;
c. the tab having an aperture formed therethrough, the aperture residing over the neck of the container;
d. the pour channel having a plurality of substantially planar panels connected to one another by a plurality of score lines; and
e. the pour channel being in substantially flat condition for storage and transport and being expandable to receive the pourable material being dispensed from the container;
f. wherein the tab and the pour channel are connected to one another by a juncture having a slit formed therethrough.

2. The container and nozzle described in claim 1, further comprising a plurality of radially oriented slits emanating from the aperture.

3. The container and nozzle described in claim 1, wherein the pour channel is configured with two thicknesses of sheet material when in the flat condition.

4. The container and nozzle described in claim 1, wherein the slit comprises three slits.

5. The container and nozzle described in claim 4, wherein the three slits comprise a central slit positioned at the approximate center of the juncture and two side slits positioned at the opposite ends of the juncture.

6. The container and nozzle described in claim 5, wherein when the pour channel is expanded, the central slit extends toward the neck of the container and the side slits extend away from the neck of the container to allow the pour channel to expand with minimum distortion.

7. The container and nozzle described in claim 1, wherein the sheet material is a paperboard sheet treated with a coating that is resistant to liquid absorption.

8. The container and nozzle described in claim 1, wherein the pour channel is narrower at the bottom than at the top thereof.

9. A nozzle for use with a container holding pourable material, the nozzle comprising:
a. a tab connected to a pour channel;
b. the tab having an aperture formed therethrough, the aperture sized for mounting on a neck of the container;
c. the pour channel formed of a plurality of substantially planar panels connected to one another by a plurality of score lines; and
d. the pour channel being in substantially flat condition for storage and transport and being expandable to dispense the pourable material from the container;
e. wherein the tab and the pour channel are connected to one another by a juncture, and further comprising a slit formed along the juncture.

10. The nozzle described in claim 9, further comprising a plurality of radially oriented slits emanating from the aperture.

11. The nozzle described in claim 9, wherein the pour channel is configured with two thicknesses of sheet material when in the flat condition.

12. The nozzle described in claim 9, wherein the slit is centrally located on the juncture and further comprising two slits located at the opposite ends of the juncture.

13. The nozzle described in claim 10, wherein when the pour channel is expanded, the central slit extends toward the neck of the container and the side slits extend away from the neck of the container to allow the pour channel to expand with minimum distortion.

14. The nozzle described in claim 12, wherein when the pour channel is expanded, the central slit extends toward the neck of the container and the side slits extend away from the neck of the container to allow the pour channel to expand with minimum distortion.

15. The nozzle described in claim 11, wherein the sheet material is a paperboard sheet treated with a coating that is resistant to liquid absorption.

16. The nozzle described in claim 9, wherein the pour channel is narrower at the bottom than at the top thereof.
